(19) United States
(12) Patent Application Publication
(10) Pub. No.: US 2002/0169825 A1
(43) Pub. Date: Nov. 14, 2002

(54) XML-enabled control and monitoring method and apparatus

(76) Inventors: Benson Hougland, Temecula, CA (US); David H. Hill, Oceanside, CA (US); Kevin Kuhns, Temecula, CA (US); James W. Frederick, Temecula, CA (US); Ken Johnson, Temecula, CA (US)

Correspondence Address: Pillsbury Winthrop LLP, Intellectual Property Group, 50 Fremont Street, San Francisco, CA, 94105, US

(21) Appl. No.: 09/854,186

(22) Filed: May 11, 2001

(51) Int. Cl. G06F 15/16

(52) U.S. Cl. 709/203

(57) ABSTRACT

A control method, apparatus, and system capable of monitoring or controlling. Aspects of the present invention relate in general to a system that controls and monitors remote devices through a standard interface that easily facilitates human or machine input through remote electronic data interchange. The system, method and apparatus enable monitoring and control through the exchange of extensible Markup Language (XML) formatted data.

### BACKGROUND

1. Field of the Invention

Aspects of the present invention relate in general to a system that controls and monitors remote devices through a standard interface that easily facilitates human or machine input through remote electronic data interchange. The system, method and apparatus enable monitoring and control through the exchange of extensible Markup Language (XML) formatted data.

2. Description of the Related Art

Conventionally, remote monitoring or control systems have been difficult to integrate. In the past, systems relied on dedicated line to communicate between a control system and a remote sensor or actuator device. This limited the controlled device or system to respond to one single computer at a remote location. With the growth of the Internet and local area networking technology, it became possible for a multiple remote locations to monitor data from or control a device. However, the myriad of differing vendors and control standards, often devices made by different manufacturers could not talk to each other. Worse yet, devices optimized for easy control or remote monitoring by people required different control interfaces when being remotely monitored or controlled by machines.

### BRIEF DESCRIPTION OF THE DRAWINGS

FIG. 1 illustrates an embodiment of a system that controls and monitors remote devices through a standard interface that easily facilitates human or machine input through remote electronic data interchange.

FIG. 2 is a block diagram of an embodiment of an apparatus that that controls and monitors remote devices through a standard interface that easily facilitates human or machine input through remote electronic data interchange.

FIG. 3 is a block diagram of an alternate embodiment of an apparatus that that controls and monitors remote devices through a standard interface that easily facilitates human or machine input through remote electronic data interchange.

FIG. 4 is a block diagram of a brain module of the embodiment shown FIG. 3.

FIG. 5 is a block diagram of another alternate embodiment of an apparatus that that controls and monitors remote devices through a standard interface that easily facilitates human or machine input through remote electronic data interchange.

FIG. 6 is an act diagram of an apparatus that that controls and monitors remote devices through a standard interface that easily facilitates human or machine input through remote electronic data interchange.

FIG. 7 is a diagram of a standard interface that easily facilitates human input through remote electronic data interchange.

FIG. 8 flowcharts a method embodiment that easily facilitates human input through remote electronic data interchange.

### DETAILED DESCRIPTION

What is needed is an easy-to-use system, apparatus and method that controls and monitors remote devices through a standard interface that easily facilitates human or machine input through remote electronic data interchange.

Aspects of the present invention include a system, method and apparatus that facilitates the monitoring and control of a device through the exchange of extensible Markup Language (XML) formatted data. The embodiments of the present invention include a system, apparatus and method that send and receive XML formatted monitoring and control data.

The receiving of XML control information by control system embodiments allows individual users to control a system through an XML-enabled browser when combined with XML formatting information, such as an XML schema, Document Type Definition (DTD) or Cascading Style Sheet (CSS). Moreover, the use of XML makes the control and monitoring interface machine-friendly. For example, embodiments may send XML-formatted monitoring data to remote computers. Such data may be easily imported into a remote computer database. Furthermore, since embodiments understand XML-formatted control information, the control of the system may be affected by the directly sending XML-formatted control information from the remote computer database.

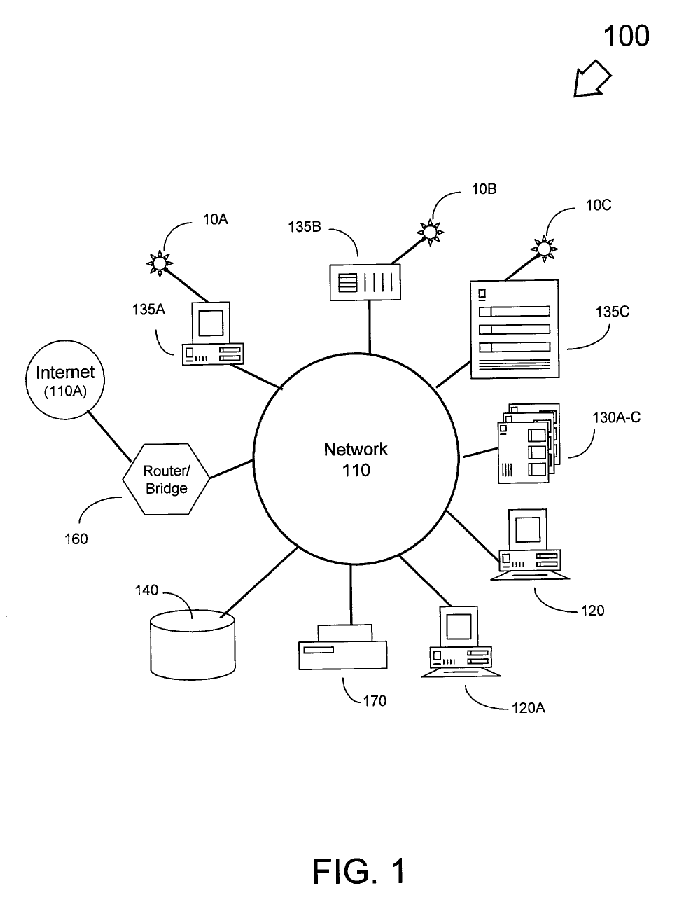

FIG. 1 is a simplified functional act diagram depicting system 100, constructed and operative in accordance with an embodiment of the present invention. System 100 is configured to control and monitor remote devices through a standard interface that easily facilitates human or machine input through remote electronic data interchange.

An embodiment of the control method identifies the type of incoming data, parses the instructions, and implements them on the monitoring device 135.

In system 100, remote computers 120 are connected via a communications network 110. The remote computers 120 may communicate to monitoring device 135 via network 110. It is understood by those known in the art, that either the remote computers 120 or monitoring device 135 may be coupled via a single or multiple number of networks without inventive faculty. Furthermore, the number of computers 120 and control devices 135 may vary from system to system.

In some embodiments, monitoring device 135 may be a personal computer, personal digital assistant (PDA), wireless phone, or other such network-computing device.

The network 110 may also include other networkable devices known in the art, such as computers 120, storage media 140, other control devices 135, servers 130, printers 170, and network devices 160 such as routers or bridges 160. It is well understood in the art, that any number or variety of computer networkable devices or components may be coupled to the network 110 without inventive faculty. Examples of other devices include, but are not limited to, servers, computers, workstations, terminals, input devices, output devices, printers, plotters, routers, bridges, cameras, sensors, or any other such device known in the art.

Monitoring device 135 may be any apparatus known in the art that are able to monitor inputs from sensors 10. Sensors are any devices known in the art able to collect input data relevant to a control function. In FIG. 1, three exemplary embodiments of monitoring device 135A-C are shown, each connected to at least one sensor 10. It is understood that monitoring device 135 may be connected to any number of sensors 10.

Network 110 may be any communication network known in the art, including the Internet, a local-area-network (LAN), a wide-area-network (WAN), or any system that links a computer to an monitoring device 135. Further, network 110 may be of configured in accordance with any topology known in the art, including star, ring, bus, or any combination thereof.

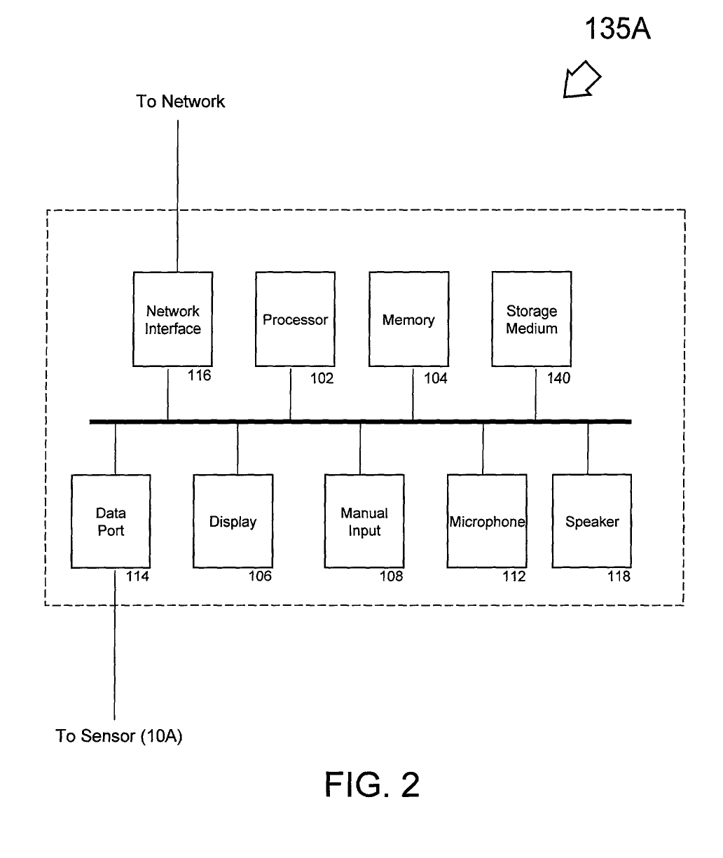

Embodiments will now be disclosed with reference to a block diagram of an exemplary monitoring device 135A of FIG. 2, constructed and operative in accordance with an embodiment of the present invention. Monitoring device 135 runs a multi-tasking operating system and includes at least one processor or central processing unit (CPU) 102. Processor 102 may be any microprocessor or micro-controller as is known in the art.

The software for programming the processor 102 may be found at a computer-readable storage medium 140 or, alternatively, from another location across network 110. Processor 102 is connected to computer memory 104. Monitoring device 135 may be controlled by an operating system (OS) that is executed within computer memory 104.

Processor 102 communicates with a plurality of peripheral equipment, including network interface 116, and data port 114. Additional peripheral equipment may include a display 106, manual input device 108, storage medium 140, microphone 112, and speaker 118.

Computer memory 104 is any computer-readable memory known in the art. This definition encompasses, but is not limited to: Read Only Memory (ROM), Random Access Memory (RAM), flash memory, Erasable-Programmable Read Only Memory (EPROM), non-volatile random access memory, memory-stick, magnetic disk drive, transistor-based memory or other computer-readable memory devices as is known in the art for storing and retrieving data.

Storage medium 140 may be a conventional read/write memory such as a magnetic disk drive, magneto-optical drive, optical drive, floppy disk drive, compact-disk read-only-memory (CD-ROM) drive, digital video disk read-only-memory (DVD-ROM), digital video disk read-access-memory (DVD-RAM), transistor-based memory or other computer-readable memory device as is known in the art for storing and retrieving data. Storage medium 140 may be remotely located from processor 102, and be connected to processor 102 via a network 110 such as a local area network (LAN), a wide area network (WAN), or the Internet.

Display 106 may be a visual display such as a cathode ray tube (CRT) monitor, a liquid crystal display (LCD) screen, touch-sensitive screen, or other monitors as are known in the art for visually displaying images and text to a user.

Manual input device 108 may be a conventional keyboard, keypad, mouse, trackball, or other input device as is known in the art for the manual input of data.

Microphone 112 may be any suitable microphone as is known in the art for providing audio signals to processor 102. In addition, a speaker 118 may be attached for reproducing audio signals from processor 102. It is understood that microphone 112, and speaker 118 may include appropriate digital-to-analog and analog-to-digital conversion circuitry as appropriate.

Data port 114 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’). In some embodiments, data port 114 may communicate to external accessories using any interface as known in the art for communicating or transferring files across a computer network. Examples of such networks include Transmission Control Protocol/Internet Protocol (TCP/IP), Ethernet, Fiber Distributed Data Interface (FDDI), ARCNET, token bus, or token ring networks.

Network interface 116 is any interface as known in the art for communicating or transferring files across a computer network, examples of such networks include Transmission Control Protocol/Internet Protocol (TCP/IP), Ethernet, Fiber Distributed Data Interface (FDDI), ARCNET, token bus, or token ring networks.

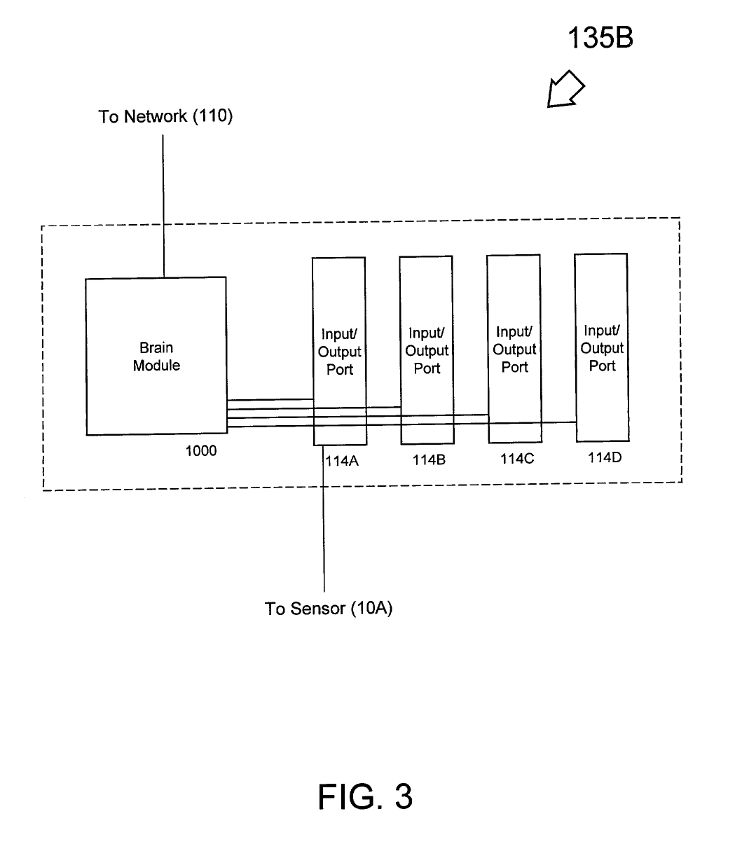

FIG. 3 depicts monitoring device 135B, constructed and operative in accordance with an alternate embodiment of the present invention. In this embodiment, monitoring device 135 is an input-output monitoring and device. Monitoring device 135B comprises a brain module 1000 coupled to at least one input/output port 1114. For illustrative purposes only, in FIG. 3, four input/output ports 114A-D are depicted. It is understood that control device may have any number of input/output ports 114.

Input/output modules, sensors 10, actuators, control modules, like equipment and any other device to be controlled by monitoring device 135B may be plugged into one of the input/output ports 114.

A brain module 1000 may be any machine intelligence that is able to communicate with the input/output ports 114, and interface the data received with a remote computer 120 over network 110. Brain module 1000 may also execute programs, encoded on computer-readable medium, to execute control functions to manipulate devices, such as sensor 10, connected to input/output ports 114.

In some embodiments, the interface between brain module 1000 and the input/output ports 114 may be a serial or parallel link. In other embodiments, the interface may be any interface as known in the art for communicating or transferring files across a computer network, examples of such networks include Transmission Control Protocol/Internet Protocol (TCP/IP), Ethernet, Fiber Distributed Data Interface (FDDI), ARCNET, token bus, or token ring networks.

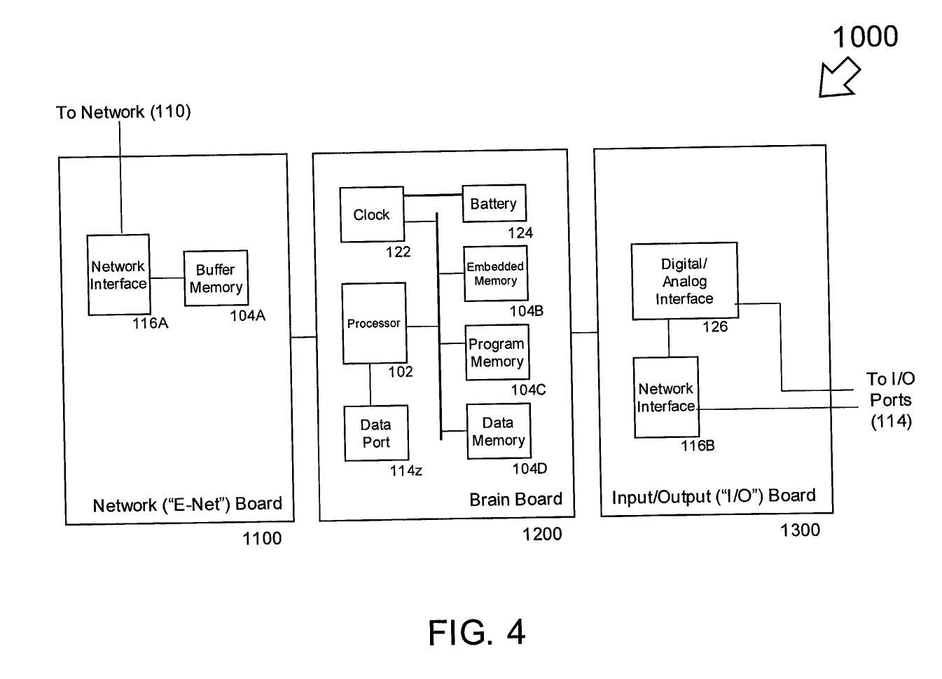

Brain module 1000 is depicted in greater detail in FIG. 4, constructed and operative in accordance with an embodiment of the present invention. As shown, brain module 1000 comprises a network (“e-net”) board 1100, a brain board 1200, and an input/output (“I/O”) board 1300.

Network board 1100 comprises network interface 116A and buffer memory 104A.

In some embodiments, the components of the three boards 1100 1200 1300 may be combined into a single board or divided differently without altering the scope of the invention. In one embodiment of the present invention, the three boards 1100 1200 1300 are integrated into a single device. As discussed above, network interface 116A may be any interface as known in the art for communicating or transferring files across a computer network. Buffer memory 104A is any computer readable memory used to buffer data being received from or sent to network interface 116 from brain board 1200.

Brain board 1200 is a structure that provides intelligence for monitoring device 135, comprising a processor 102 and memory 104. In the embodiment depicted, three different kinds of memory are shown. Embedded memory 104B is memory containing the program structures initially used by monitoring device 135. These programs may include the initialization procedures, control programs, or monitoring programs. Program memory 104C is memory dedicated to the execution of computer programs. Data memory 104D is used to store data collected through the monitoring or control of the connected sensors, actuators, or other monitoring or control devices. In some embodiments, program memory 104C and data memory 104D are combined into a single memory.

As shown, brain board 1200 may also comprise data port 114z, a real time clock 122 and batter 124. Data port 114z provides processor 102 a serial or parallel interface to communicate with diagnostic tools or other equipment. Clock 122 provides brain board 1200 date and time information. To insure the integrity of the date and time information during blackouts, battery 124 provides backup power.

Input/output (“I/O”) board 1300 provides brain board 1200 an interface to the input/output ports 114A-D. Digital/Analog Interface couples to any input/output port 114 and converts any analog signals received (from analog modules) to digital data. Network interface 116B communicates to any input/output port 114 that communicates via a computer networking protocol, as discussed above.

In an alternate embodiment, the intelligence of monitoring device 135 may be located in a plug-in module. Take, for or example, a programmable logic controller (PLC) embodiment. A programmable logic controller is a ladder-logic controlled device cable of controlling a plurality of attached devices. In a programmable logic controller, or any other a device with limited computing capability, the device alone may not have network capability or have the processing throughput to enable the network control or monitoring. In such a device, a plug-in module may be utilized to provide the intelligence, and network capability.

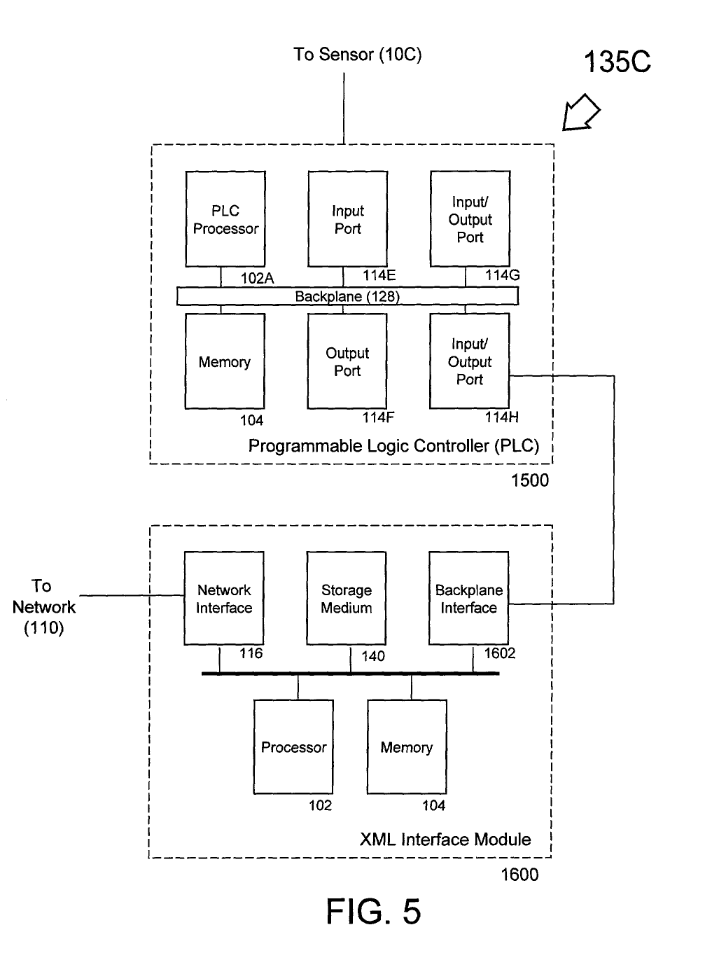

FIG. 5 depicts monitoring device 135C, constructed and operative in accordance with an alternate embodiment of the present invention. It is understood that the use of a programmable logic controller 1500 in combination with an XML interface module 1600 is just one example embodiment. In an embodiment where the intelligence is located on the XML interface module 1600, monitoring device 135 may comprise an XML interface module 1600 combined with an input-output monitoring and device, programmable logic controller, or any other computing device.

Programmable logic controller 1500 comprises a programmable logic controller processor 102A, memory 104, and a series of input/output ports 114E-H connected to a communications backplane 128.

XML interface module 1600 may couple to the backplane 128 via an input/output port 114H, as shown, or be connected directly to the backplane 128. XML interface module comprises a processor 102, memory 104, computer-readable storage medium 140, network interface 116, and backplane interface 1602.

Processor 102 may be any microprocessor or micro-controller as is known in the art. Additionally, XML interface module 1600 may run a real time operating system, which may be embedded on storage medium 140. Additionally, software programming the processor 102 may also be found at computer-readable storage medium 140 or, alternatively, from another location across network 110.

Memory 104 may be any computer-readable memory as is known in the art, as discussed above.

Storage medium 140 may be any computer-readable storage as is known in the art, as discussed above.

Network interface 116 may be any interface as known in the art for communicating or transferring files across a computer network. Examples of such networks include Transmission Control Protocol/Internet Protocol (TCP/IP), Ethernet, Fiber Distributed Data Interface (FDDI), ARCNET, token bus, or token ring networks. A remote user using computer 120A may communicate with monitoring device 135C via the network 110 and network interface 116.

Backplane interface 1602 allows XML interface module 1600 to communicate with backplane 128, and thus monitor and control devices attached to programmable logic controller 1500. Backplane 128 signals include addressing, control, data, and power.

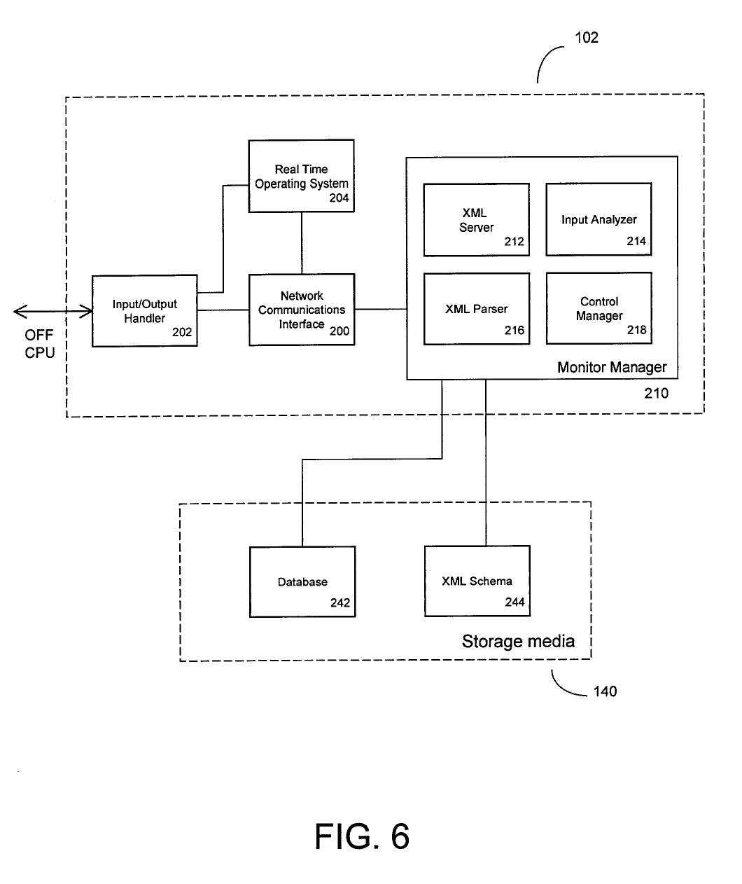

FIG. 6 is an expanded functional act diagram of processor 102 and storage medium 140, constructed and operative in accordance with an embodiment of the present invention. It is well understood by those in the art, that the functional act elements of FIG. 6 may be implemented in hardware, firmware, or as software instructions and data encoded on a computer-readable storage medium 140. Furthermore, it is understood that these structures may be implemented in conjunction with the embodiments described in FIGS. 1-5 above, or separately on their own. As shown in FIG. 6, central processing unit 102 comprises an input/output handler 202, a real time operating system 204, a network communications interface 200, and a monitor manager 210. In addition, as shown in FIG. 56, storage media 140 may also contain a database 242, and an XML schema 244.

Input/output handler 202 interfaces devices off the processor 102. In some embodiments, these devices include display 106, manual input device 108, storage medium 140, microphone 112, input/output port 114, and network interface 116. The input/output handler 202 enables processor 102 to locate data on, read data from, and write data to, these components.

Real time operating system 204 enables processor 102 to take some action with respect to a separate software application or entity. For example, real time operating system 204 may take the form of a windowing user interface, as is commonly known in the art.

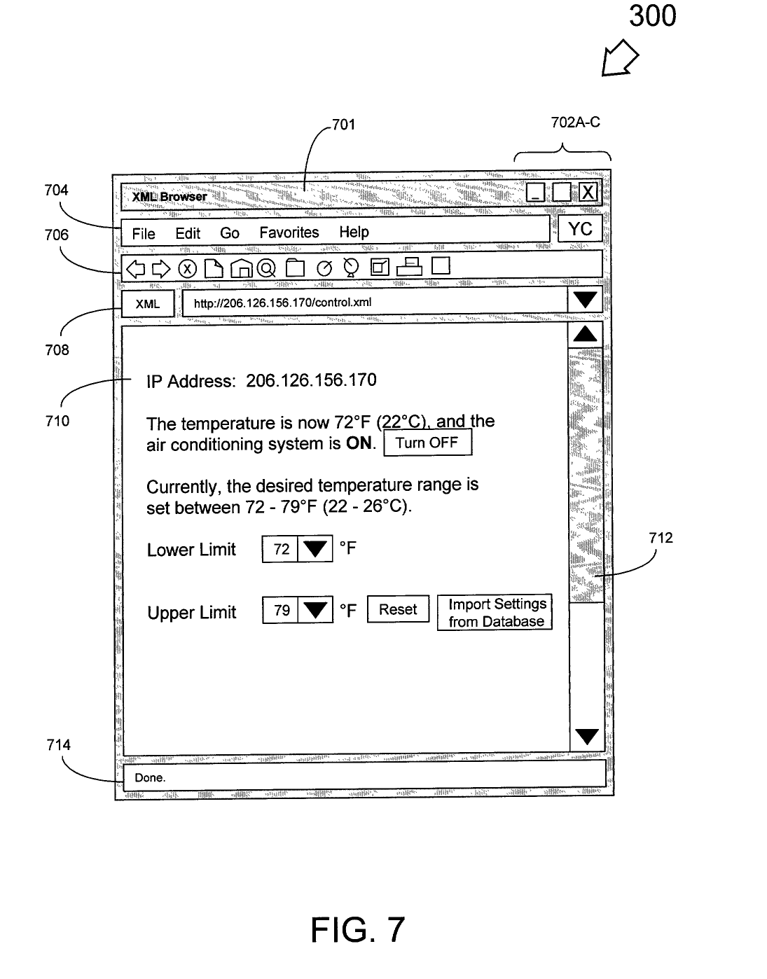

Network communications interface 200 is an XML-enabled user interface. In some embodiments, the network communications interface 200 may be stand-alone program, or an XML browser window. An example of such an XML browser window is shown in FIG. 7. XML browser window 200 comprises title bar 701, window control buttons 702A-C, menu bar 704, button bar 706, address bar 708, main frame 710, main frame 712, and status frame 714.

In some embodiments, main frame 710 displays XML data received from monitor manager 210 formatted by an XML schema, Document Type Definition (DTD) or Cascading Style Sheet (CSS).

Returning to FIG. 6, monitor manager 210 may further comprise an XML server 212, an input analyzer 214, an XML parser 216, and a control manager 218.

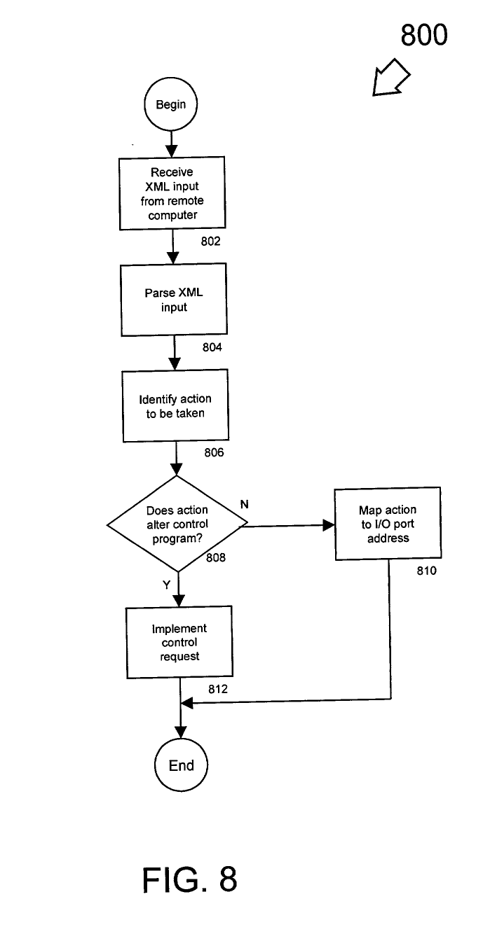

These components of monitor manager 210 interact with a database 242, and XML schema 244, and may best be understood with respect to the flowchart, FIG. 8, as described below.

FIG. 8 flowcharts a process 800 to easily facilitate human input through remote electronic data interchange, constructed and operative in accordance with an embodiment of the present invention.

XML server 212 formats data output from devices attached to data port or input/output port 114. Once the data is XML formatted, network communications interface 200 may send the formatted data to XML enabled devices or interfaces.

Using an XML browser, users may also send XML formatted data to monitoring device 135. For example, in some embodiments this may be accomplished through a HyperText Transfer Protocol (HTTP) post. In other embodiments, the XML formatted data may be transferred using other communications protocols, such as File Transfer Protocol (FTP), Remote CoPy (RCP) and the like.

Such input data is received by monitor manager 210, act 802, and parsed into tokens by XML parser 216, act 804. XML parser 216 may be any parser known in the art capable of parsing eXtensible Markup Language (XML) formatted information. Once parsed into tokens, the input analyzer 214 examines the tokens and determines the actions to be taken as a result of the input, act 806.

If the actions relate to reading sensor data or other input from data port 114, as determined by act 808, monitor manager 210 maps the action to the input/output port specified by the data, at act 810. For example, if the action is to retrieve data, the monitor manager 210 then queries the appropriate data port 114 for input.

If the actions relate to controlling an input/output module, actuator, or other such device, as determined by act 808, input analyzer 214 forwards the information to control manager 218 which handles the control request, act 812. Control manager 218 is any structure known in the art that executes control functions on input/output modules or actuator-like devices.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. An apparatus comprising:
a network interface configured to receive an input formatted in eXtensible Markup Language from a remote computer;
a parser, coupled to the network interface, configured to parse the input, configured to determine a control action encoded within the input.

2. The apparatus of claim 1,
a data port configured to receive an input/output module.

3. The apparatus of claim 2, wherein the control action specifies the address of the input/output module.

4. The apparatus of claim 3,
an input analyzer, coupled to the parser, configured to map the control action to the input/output module.

5. The apparatus of claim 4,
a control manager, coupled to the input analyzer, configured to initiate the control action with the input/output module.

6. A method comprising:
receiving an eXtensible Markup Language input containing an action relevant to a control function;
executing the action relevant to the control function.

7. The method of claim 6, further comprising:
parsing the eXtensible Markup Language input to determine the action relevant to the control function.

8. The method of claim 7, wherein the eXtensible Markup Language input is received from a remote computer.

9. The method of claim 8, further comprising:
mapping the action relevant to the control function to an address of an input/output module.

10. A computer-readable medium encoded with data and instructions, the data and instructions causing an apparatus executing the instructions to:
receive an eXtensible Markup Language input containing an action relevant to a control function;
execute the action relevant to the control function.

11. The computer-readable medium of claim 10 further encoded with data and instructions, further comprising:
parsing the extensible Markup Language input to determine the action relevant to the control function.

12. The computer-readable medium of claim 11, wherein the extensible Markup Language input is received from a remote computer.

13. The computer-readable medium of claim 12 further encoded with data and instructions, further comprising, further comprising:
means for mapping the action relevant to the control function to an address of an input/output module.

14. An apparatus comprising:
means for receiving an extensible Markup Language input containing an action relevant to a control function;
means for executing the action relevant to the control function.

15. The apparatus of claim 14, further comprising:
means for parsing the extensible Markup Language input to determine the action relevant to the control function.

16. The apparatus of claim 15, wherein the extensible Markup Language input is received from a remote computer.

17. The apparatus of claim 16, further comprising:
means for mapping the action relevant to the control function to an address of an input/output module.
